(19) United States
(12) Patent Application Publication
(10) Pub. No.: US 2025/0246607 A1
(43) Pub. Date: Jul. 31, 2025

(54) CATHODE ACTIVE MATERIAL COATING ON CARBON STRUCTURES FOR BATTERIES

(71) Applicant: The Regents of the University of California, Oakland, CA (US)

(72) Inventors: Haegyum Kim, Emeryville, CA (US); Sizhuo Yang, Walnut Creek, CA (US); Jeffrey J. Urban, Emeryville, CA (US); Young-Woon Byeon, Seoul (KR)

(21) Appl. No.: 19/036,597

(22) Filed: Jan. 24, 2025

Related U.S. Application Data
(60) Provisional application No. 63/627,267, filed on Jan. 31, 2024.

(51) Int. Cl. H01M 4/36; H01M 4/02; H01M 4/131; H01M 4/137; H01M 4/525; H01M 4/60; H01M 4/62; H01M 10/058

(52) U.S. Cl. CPC H01M 4/366; H01M 4/131; H01M 4/137; H01M 4/525; H01M 4/604; H01M 4/608; H01M 4/625; H01M 10/058; H01M 2004/028

(57) ABSTRACT

This disclosure provides systems, methods, and apparatus related to battery components and methods of making thereof. In one aspect, a method includes depositing a polymer coating on cathode material particles to be used in a battery. The polymer coating gives the cathode material particles a positive charge. The cathode material particles are mixed with carbon structures. The carbon structures have a negative charge. The cathode material particles become attached to surfaces of the carbon structures.

### RELATED APPLICATIONS

This application claims priority to U.S. Provisional Patent Application No. 63/627,267, filed Jan. 31, 2024, which is hereby incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

All-solid-state batteries (ASSBs) hold great promise, including improved safety and higher energy density compared with conventional lithium-ion batteries (LIBs), as the non-flammable solid electrolyte (SE) can be combined with an energy-dense lithium-metal anode. Given these technical advantages, various types of SEs have been studied and developed, including sulfides, halides, and oxides as well as their polymer composites. Among these materials, sulfide-based SEs exhibit superior ionic conductivity of 10⁻³ to 10⁻⁴ S cm⁻¹ at room temperature, which is even comparable to that of liquid organic electrolytes. However, sulfide-based SEs have a narrow electrochemical stability window and poor chemical/electrochemical compatibility with electrodes, which remain grand challenges.

Argyrodite (Li₆PS₅X, X═Cl, Br) SEs possess both high ionic conductivity and relatively good interfacial compatibility against a lithium-metal anode compared with other sulfide SEs such as Li₁₀GeP₂S₁₂ and Li₃PS₄ electrolytes. However, in the composite cathode, both the cathode active material (CAM)/argyrodite SE and carbon/argyrodite SE interfaces are not thermodynamically stable. Recent studies have demonstrated that inorganic coating layers such as LiNbO₃ (LNO), Li₂O—ZrO₂ (LZO), and Li_{1.175}Nb_{0.645} Ti_{0.4}O₃ (LNTO) can suppress the degradation at the CAM/argyrodite SE interface. Whereas cation substitutions barely affect their intrinsic oxidative electrochemical stability when sulfur remains a major part of the chemical composition, partial substitution of oxygen with sulfur has been suggested to increase the oxidation limit. Coating of halide SEs with higher oxidative stability on the CAM also results in improved cycling stability as the formation of a detrimental interface between the CAM and argyrodite SE can be avoided, and the halide SE functions as a Li-conducting buffer layer in this composite cathode design.

The use of an electronically conductive carbon additive in the composite cathode provides facile electron transfers to the CAMs and creates uniform current distributions. However, sulfide SEs, including argyrodites, are readily decomposed when they form an interface with the conductive carbon, and the decomposition is even accelerated when the composite cathode is charged to high voltage. Recent studies show that the morphology and quality (i.e., defects and functional groups) of carbon significantly affect the electrochemical performance of ASSBs. For example, one study showed that the low-surface-area carbon (vapor-grown carbon fiber) delivered a lower irreversible capacity in the composite cathode than high-surface-area carbon (carbon black). Another study demonstrated that the use of graphitized carbon with fewer functional groups in the composite cathode improved the reversible capacity and cycling stability.

Although a conductive carbon coating on the CAM surface is frequently used in conventional LIBs to improve the electronic conductivity of the cathode, this approach is not suitable for ASSBs using sulfide SEs because the coated carbon must contact the SEs, which would lead to detrimental decomposition reactions (FIG. 1A). FIG. 1A shows a cathode structure 105 including CAM particles (also referred to as cathode material particles herein) 115 having a carbon coating 125 disposed thereon mixed with solid electrolyte particles 120. Therefore, low-surface-area carbon nanofibers (CNFs) or carbon nanotubes (CNTs) are widely used in the composite cathode of ASSBs. These low-surface-area carbon additives can reduce the interfacial area between carbon and SEs. However, the homogeneously mixed CNFs with CAM and SE cannot prevent direct contact between the carbon additive and SEs, and these interfaces cannot be controlled (FIG. 1B). FIG. 1B shows a cathode structure 110 including CAM particles 115 mixed with solid electrolyte particles 120 and carbon structures 130. The carbon structures 130 shown in FIG. 1B are carbon nanofibers. In a recent study, a research group developed zinc oxide (ZnO)-coated CNF to reduce the contact area between the carbon additive and SEs.

### SUMMARY

Described herein is a cathode active material coating on a conductive carbon framework to be used for a cathode composite in solid-state batteries. In the lithium-ion battery system, a conductive carbon coating is often used to improve the electronic conductivity of cathode active materials. In solid-state batteries, however, it is important to avoid detrimental interfaces between an electronic conductive carbon and a solid electrolyte, especially for sulfide-based solid electrolytes.

The methods described herein generate a structure where the surface of a conductive carbon framework is decorated by cathode active materials. In such a structure, electrons can be provided to the cathode active material through the carbon framework while avoiding direct contact between the conductive carbon and solid electrolyte.

The methods described herein include applying a polymer coating (e.g., polyethylenimine (PEI)) that has a positive charge to surfaces of a cathode active material. Then, the cathode active material is combined with a carbon material with negatively charged surfaces; the negatively charged surfaces are due to the intrinsic oxygen containing functional groups and defects in the carbon material. This method can be applied to various cathode active materials including LiCoO₂, LiNiₓCo_{y}Mn_{z}O₂, and LiFePO₄, and various forms of carbon.

One innovative aspect of the subject matter described in this disclosure can be implemented in a method including depositing a polymer coating on cathode material particles to be used in a battery. The polymer coating gives the cathode material particles a positive charge. The cathode material particles are mixed with carbon structures. The carbon structures have a negative charge. The cathode material particles become attached to surfaces of the carbon structures.

Another innovative aspect of the subject matter described in this disclosure can be implemented in a device including a cathode, a solid electrolyte disposed on the cathode, and an anode disposed on the solid electrolyte. The cathode comprises cathode material particles, solid electrolyte particles, and carbon structures. The cathode material particles have a polymer coating disposed on surfaces of the cathode material particles. The cathode materials particles are disposed on surfaces of the carbon structures.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of schematics of carbon-CAM composites with SEs. FIG. 1A-Carbon-coated CAM mixture with SEs. FIG. 1B-Mixture of CAM, CNF, and SE.

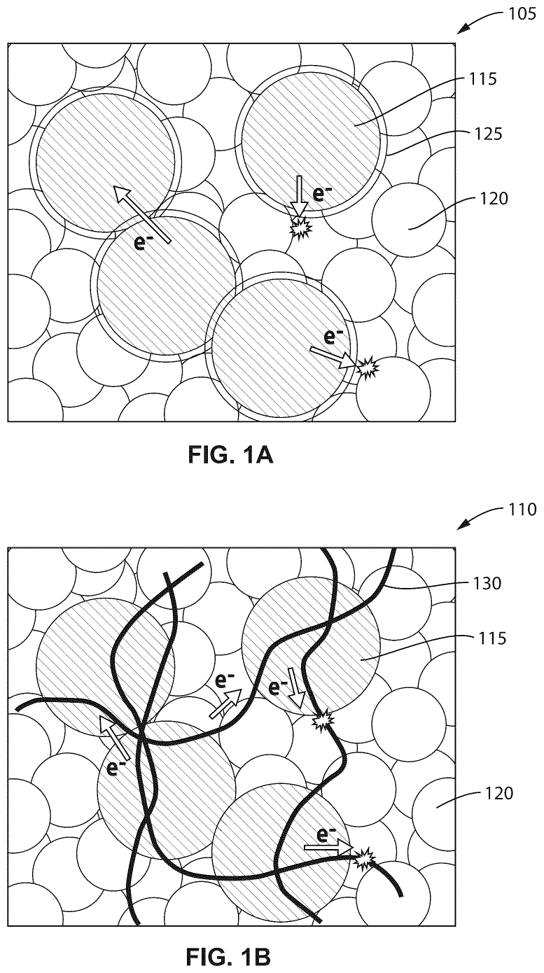

FIG. 2 shows an example of a schematic diagram of the fabrication of the CAM-RGO framework composite.

FIGS. 3A-3F show examples of the materials characterization of pc-NMC811/RGO composites at varied RGO contents. FIG. 3A-TGA results, FIG. 3B-XRD patterns, and FIGS. 3C-3F-SEM images of pc-NMC811/RGO composites.

FIG. 4A-4D show examples of Raman mapping based on K-means clustering analysis for composite cathodes comprising pc-NMC811/RGO and LPSC1 SE (FIGS. 4A and 4C) and composite cathodes comprising pc-NMC811, CNF, and LPSC1 SE (FIGS. 4B and 4D). The black dotted line indicates the location of the composite cathode|LPSC1 interface.

FIG. 5A-5C show examples of the electrochemical properties of pc-NMC811/RGO composites. FIG. 5A shows examples of the first charge-discharge profiles of pc-NMC811/RGO composites with varied RGO contents. Composite cathodes with CNF and no carbon are used as control groups. FIG. 5B shows examples of the initial charge and discharge capacities of pc-NMC811/RGO composites and control groups. The right y-axis indicates the coulombic efficiency at the first cycle. FIG. 5C shows examples of the cycling stability of pc-NMC811/RGO composites and control groups.

FIGS. 6A-6E show examples of the materials characterization of sc-NMC622/RGO composites at varied RGO contents. FIG. 6A-TGA results, FIG. 6B-XRD patterns, and FIGS. 6C-6E-SEM images of sc-NMC622/RGO composites.

FIGS. 7A-7D show examples of the electrochemical properties of sc-NMC622/RGO composites. FIG. 7A shows an examples charge-discharge profiles of sc-NMC622/RGO composites with varied RGO contents. FIG. 7B shows examples of the cycling stability of sc-NMC622/RGO composites. FIG. 7C shows examples of the cycling stability of 2.0 wt % RGO composite at C/5 and C/10. FIG. 7D shows examples of the rate capability of 2.0 wt % RGO composite.

FIG. 8 shows an example of a flow diagram illustrating a fabrication process for a cathode composite.

FIG. 9A shows an example of a cross-sectional schematic illustration of a solid-state battery. FIG. 9B shows an example of a schematic illustration of a cathode composite.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Described herein is an CAM-carbon structure where an electronically conductive carbon framework is embedded beneath CAM particles. In this structure, electron transfers to CAM particles can be facilitated through the carbon framework while the detrimental interface between the carbon additive and SE can be avoided or at least minimized when this CAM-carbon structure is mixed with a SE.

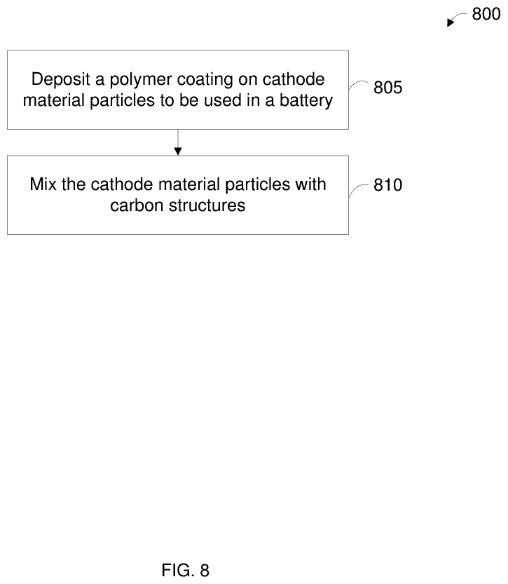

FIG. 8 shows an example of a flow diagram illustrating a fabrication process for a cathode composite. In some embodiments, the cathode composite is used in a battery. In some embodiments, the cathode composite is used in a solid-state battery.

Starting at block 805 of the method 800 shown in FIG. 8, a polymer coating is deposited on cathode material particles. The polymer coating gives the cathode material particles a positive charge or imparts a positive charge to the cathode materials.

In some embodiments, the polymer of the polymer coating comprises a cationic polymer. In some embodiments, the polymer of the polymer coating is a polymer from a group polyethylenimine (PEI), poly(L-lysine) (PLL), poly(amidoamine) (PANAM), and poly(B-amino ester). In some embodiments, the polymer coating deposited on the cathode material particles is about 1 nanometer (nm) to 20 nm thick, or about 3 nm to 5 nm thick.

In some embodiments, the cathode material particles are a material from a group lithium nickel cobalt oxide, lithium nickel cobalt manganese oxide, lithium nickel cobalt aluminum oxide, lithium iron phosphate, lithium iron manganese phosphate, and doped-compositions of the foregoing. For the doped compositions, the dopants are less than about 2 atomic percent of the total transition metals. In some embodiments, the cathode material particles are a cathode material from a group LiCoO₂, LiNiₓCo_{y}Mn_{z}O₂, LiNiₓCo_{y}Al_{z}O₂, LiFePO₄, and LiFcₓMn₁₋ₓPO₄. In some embodiments, the cathode material particles have dimensions of about 0.1 microns to 100 microns.

In some embodiments, the polymer coating is deposited using a solution-based process.

Returning to FIG. 8, after block 805, at block 810 the cathode material particles are mixed with carbon structures. The carbon structures have a negative charge and the cathode material particles become attached to surfaces of the carbon structures.

In some embodiments, the carbon structures are selected from a group frameworks of a three-dimensional reduced graphene oxide (RGO), carbon nanofibers, carbon microfibers, carbon nanotubes, carbon nanosheets, carbon microsheets, carbon nanoplates, and carbon microplates. In some embodiments, the carbon structures have dimensions of about 1 micron to 1,000 microns. In some embodiments, a ratio by weight of the carbon structures to the cathode material particles is about 1:200 to 1:10.

In some embodiments, the method further include mixing the carbon structures having the cathode material particles attached to their surfaces with solid electrolyte particles. In some embodiments, the cathode material particles prevent, help to prevent, or minimize contact between the carbon structures and the solid electrolyte.

In some embodiments, the solid electrolyte particles are selected from a group sulfide-based solid electrolyte particles, oxy-sulfide-based solid electrolyte particles, halide-based solid electrolyte particle, and oxy-halide based solid electrolyte particles. In some embodiments, the solid electrolyte particles comprise lithium phosphorus sulfur chloride (LiPSC1) particles. In some embodiments, the solid electrolyte particles have dimensions of about 0.5 microns to 10 microns.

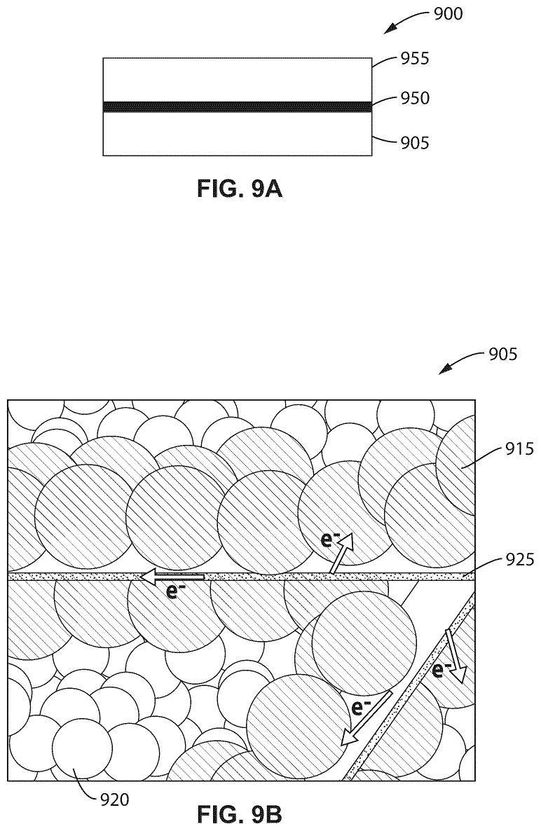

FIG. 9A shows an example of a cross-sectional schematic illustration of a battery. FIG. 9B shows an example of a schematic illustration of a cathode composite. In some embodiments, the battery is a solid-state battery. As shown if FIG. 9A, the battery 900 includes a cathode 905, a solid electrolyte disposed 950 on the cathode 905, and an anode 955 disposed on the solid electrolyte 950.

As shown in FIG. 9B, the cathode 905 comprises cathode material particles 915, solid electrolyte particles 920, and carbon structures 925. The cathode material particles 915 have a polymer coating (not shown) disposed on surfaces of the cathode material particles 915. That is, each of the cathode material particles 915 has a polymer coating disposed on its surface. The cathode materials particles 915 are disposed on surfaces of the carbon structures 925. In some embodiments, the cathode material particles 915 prevent, help to prevent, or minimize contact between the carbon structures 925 and the solid electrolyte particles 920.

In some embodiments, the cathode material particles 915 are a material from a group lithium nickel cobalt oxide, lithium nickel cobalt manganese oxide, lithium nickel cobalt aluminum oxide, lithium iron phosphate, lithium iron manganese phosphate, and doped-compositions of the foregoing. In the doped compositions, the dopants are less than about 2 atomic percent of the total transition metals. In some embodiments, the cathode material particles 915 are a cathode material from a group LiCoO₂, LiNiₓCo_{y}Mn_{z}O₂, LiNiₓCo_{y}Al_{z}O₂, LiFcPO₄, and LiFcₓMn₁₋ₓPO₄. In some embodiments, the cathode material particles 915 have dimensions of about 0.1 microns to 100 microns.

In some embodiments, the polymer coating (not shown) disposed on surfaces of the cathode material particles 915 is about 1 nm to 20 nm thick, or about 3 nm to 5 nm thick. In some embodiments, the polymer of the polymer coating comprises a cationic polymer. In some embodiments, the polymer of the polymer coating is a polymer from a group polyethylenimine (PEI), poly(L-lysine) (PLL), poly(amidoamine) (PANAM), and poly(β-amino ester).

In some embodiments, the carbon structures 925 are selected from a group frameworks of a three-dimensional reduced graphene oxide (RGO), carbon nanofibers, carbon microfibers, carbon nanotubes, carbon nanosheets, carbon microsheets, carbon nanoplates, and carbon microplates. In some embodiments, the carbon structures 925 have dimensions of about 1 micron to 1,000 microns. In some embodiments, a ratio by weight of the carbon structures 925 to the cathode material particles 915 is about 1:200 to 1:10.

In some embodiments, the solid electrolyte particles 920 are selected from a group sulfide-based solid electrolyte particles, oxy-sulfide-based solid electrolyte particles, halide-based solid electrolyte particle, and oxy-halide based solid electrolyte particles. In some embodiments, the solid electrolyte particles 920 comprise lithium phosphorus sulfur chloride (LiPSC1) particles. In some embodiments, the solid electrolyte particles 920 have dimensions of about 0.5 microns to 10 microns.

In some embodiments, the anode 955 comprises a metal. In some embodiments, the metal of the metal anode is lithium or a lithium-indium alloy. In some embodiments, the solid electrolyte 950 has the same composition as the solid electrolyte particles 920.

The embodiments described above were applied to LiNbO₃ (LNO)-coated polycrystalline LiNi_{0.8}Mn_{0.1}Co_{0.1}O₂ (pc-NMC) and LNO-coated single-crystalline LiNi_{0.6}Mn_{0.2}Co_{0.2}O₂ (sc-NMC622), as described below in the examples. These materials demonstrated improved cycling performance. The examples below are intended to be examples of the embodiments disclosed herein, and are not intended to be limiting.

### EXAMPLE—Materials Synthesis

Polyethylenimine (PEI)-coated NMC synthesis—In a typical process, 1000 mg of polyethylenimine (PEI) and 800 mg of polyvinylpyrrolidone (PVP) were dissolved in 20 mL of an EtOH/MeOH (1:1) solution. Then, 1000 mg of pc-NMC811 (or sc-NMC622) particles were dispersed in that solution at a concentration of 50 mg mL 1. The dispersion was ultrasonically treated for 1 h and then stirred at 600 rpm at RT for 24 h. The products were obtained and washed with MeOH and acetone. LNO-coated pc-NMC811 and sc-NMC622 were purchased.

Acid treatment for porous carbon—Porous carbon was treated with 4 M HNO₃ and H₂SO₄ for 1 day, centrifuged, and washed with H₂O and MeOH sequentially.

Reduced graphene oxide (RGO)—carbon composite (conductive carbon)—After treating with H₂SO₄/HNO₃, the porous carbon was mixed with single-layer graphene oxide (10:1 ratio) in H₂O and sonicated for 1 h. Then, 57% hydrogen iodide (HI) was added to the dispersion and stirred for 2 h at 90° C. After cooling down to RT, the composite was washed with water and MeOH to obtain the desired RGO-carbon composite.

Conductive carbon-CAM—PEI-coated NMC and RGO-carbon composites in different ratios were sonicated in MeOH for 2 h and stirred at RT for 24 h. The composite was then centrifuged and washed with acetone and dried in an oven to obtain the final product.

### EXAMPLE—Electrochemical Testing

The all-solid-state Li-metal batteries were constructed using a commercial battery cell enclosure system. 50 mg of LPSC1 powder (D₅₀˜ 1 μm) was pressed using two stainless-steel rods at a pressure of 100 MPa to fabricate a thin LPSC1 pellet. To fabricate the composite cathodes, the synthesized NMC/RGO composite (78 wt %) was homogeneously mixed with LPSC1 powder (22 wt %) and then uniformly applied on the LPSC1 solid-electrolyte layer. For the reference NMC/CNF composite, NMC and CNF were initially mixed to achieve homogeneity, followed by the subsequent addition of LPSC1 powder to make the composite. The composite cathode and LPSC1 SE layer were pressed under 250 MPa to secure contact between the composite cathode and SE layers. To add the anode layer, an In metal disk was first placed onto the other side of the LPSC1 pellet, followed by placing a Li-metal disk onto the indium (In) disk (composition: Li_{0.22}In_{0.78}). 7.0-7.3 mg of CAM was used for each cell, which corresponds to the CAM loading density of 9.1-9.5 mg cm 2. The assembled ASSB cell was then pressed under 30 MPa during the galvanostatic cycling performed in a voltage window of 2.5-4.3 V (vs. Li/Li⁺). All electrochemical testing was conducted using a cycler at 50° C.

### EXAMPLE—Polycrystalline LiNi_{0.8}Mn_{0.1}C_{00.1}O₂/Reduced Graphene Oxide Framework Composite Results

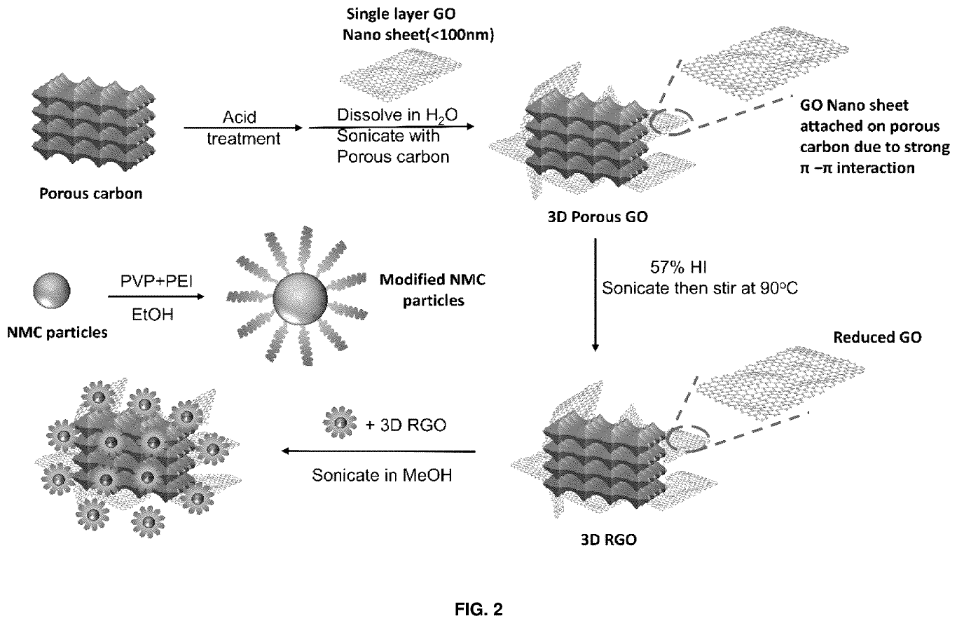

FIG. 2 illustrates the fabrication process for the CAM-3D reduced graphene oxide (RGO) framework composite. First, a porous 3D RGO framework was prepared by dispersing acid-treated porous carbon and single-layer graphene oxide (GO) in H₂O. The objective of the acid treatment of the porous carbon was to improve its dispersion ability in H₂O, which aids the hybridization with single-layer GO. After that, the porous 3D RGO framework was reduced by HI aqueous solution. The porous 3D RGO framework exhibited graphitic features, as confirmed by XRD. Typical D- and G-bands of RGO were confirmed at ˜1340 and ˜1580 cm 1, respectively, by Raman spectroscopy. The Ip/IG ratio of the RGO framework is estimated to be 0.59. In this structure, porous carbon is the framework and RGO was added to increase the electrical conductivity. After the reduction, the obtained 3D RGO framework was mixed with PEI-modified NMC in MeOH. To synthesize PEI-modified NMC particles, PVP and PEI polymers were used-PVP was used to prevent NMC particle agglomeration and PEI was used to create a positively charged surface layer on NMC particles. The resulting mixture of PEI-modified NMC and 3D RGO framework was sonicated for 2 h and stirred overnight to produce the desired CAM-carbon composite. In this process, the PEI-coated NMC particles, which have positive surface charges attracts the 3D RGO framework with the negatively charged surface. The presence of the PEI coating on pc-NMC811 was confirmed by the N—H stretching and bending peaks in the IR analysis. SEM confirmed that the pc-NMC811 particles and their morphologies were not damaged by the PEI coating process.

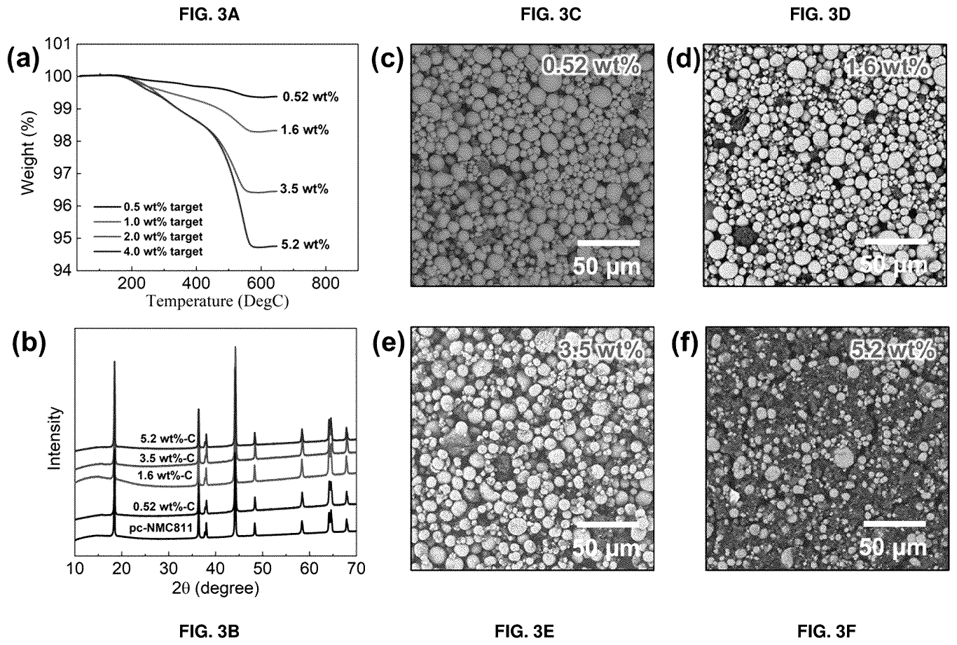

Following the synthesis process described above, LiNbO₃ (LNO)-coated polycrystalline LiNi_{0.8}Mn_{0.1}Co_{0.1}O₂/RGO composites (hereafter, pc-NMC811/RGO) with varied carbon contents were developed. The target carbon contents were 0.5 wt %, 1.0 wt %, 2.0 wt %, and 4.0 wt %. The carbon contents in the pc-NMC811/RGO composites were estimated using TGA as shown in FIG. 3A. The weight loss from 100° C. to 650° C. of the pc-NMC811/RGO is attributable to the decomposition of any carbon in the composite, which includes RGO and porous carbon. Hereafter, the RGO content is used to refer to the carbon content in the composite structure for simplicity. The RGO contents of the composites were 0.52 wt %, 1.6 wt %, 3.5 wt %, and 5.2 wt %, respectively. The RGO contents calculated from the TGA results are used in the following sections.

FIG. 3B presents XRD patterns of pc-NMC811 and its RGO composites, without any noticeable impurity phases or structure changes of pc-NMC811 after the synthesis. Figured 3C-3F present SEM images of the pc-NMC811/RGO composites with varied carbon contents. It was found that the 3D RGO framework was well covered by pc-NMC811 cathode particles (secondary particle size: 5-20 μm), and only a limited surface of the RGO framework remained uncovered by pc-NMC811 when the RGO content is below 5.2 wt %, as confirmed by the SEM images. In contrast, 3D-RGO is not fully covered by pc-NMC811 particles when a relatively high RGO content of 5.2 wt % is used (FIG. 3F). To demonstrate that pc-NMC811 particles are selectively attached on the 3D-RGO framework in the synthesis process, a control group where pc-NMC811 without PEI coating was mixed with 3D-RGO. In this control group, it was found that pc-NMC811 particles were randomly distributed and that some of the pc-NMC811 particles were not attached on the 3D-RGO framework. In contrast, all the PEI-coated pc-NMC811 particles were covered on the 3D-RGO framework, which is evidence that the PEI coating on pc-NMC811 particles plays a role in creating good contact between the pc-NMC811 particles and 3D-RGO framework.

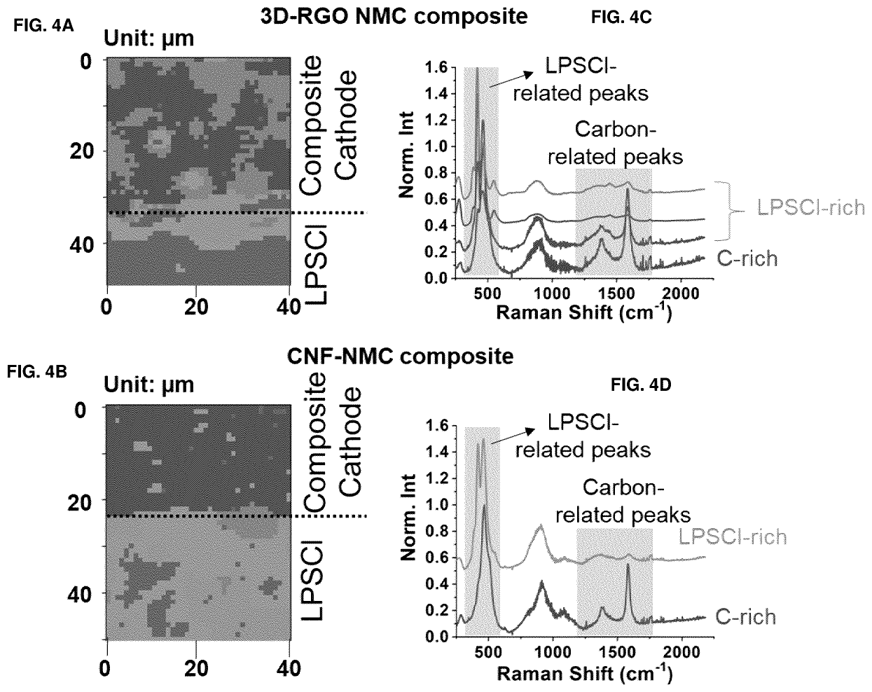

To evaluate the hypothesis that using conductive carbon embedded beneath cathode particles can reduce the interfacial area between the conductive carbon and SEs in the composite cathode, the pc-NMC811/RGO composite was mixed with LPSC1 SE, pelletized, and Raman mapping was conducted as shown in FIGS. 4A and 4C. All Raman mapping frames were analyzed using the K-means clustering algorithm, which has been proven effective in extracting heterogeneous chemical and structural information in several previous studies. The Raman peak intensities were normalized by the highest peak intensity from LPSC1 or its decomposed products at 400-600 cm 1. The lower part of the mapping area consists solely of LPSC1 SE. In FIG. 4C, the carbon-rich areas with a relatively high intensity of Raman peaks at 1200-1800 cm 1, which are typical Raman peaks from carbon (i.e., D-band at 1377 cm 1 and G-band at 1584 cm 1), are shown. The average domain size of the carbon-rich area is 10-20 μm, which is consistent with the pc-NMC811 particle size. Since pc-NMC811 particles are decorated on the RGO framework, as confirmed by the SEM images in FIGS. 3C-3F, pc-NMC811 particles are expected to be present in the carbon-rich areas. Some areas, showing a reduced intensity of the typical Raman carbon peaks, correspond to LPSC1-rich domains. Due to overlapping Raman peaks of pc-NMC811 and LPSC1, distinguishing pc-NMC811 particles from LPSC1 in the composite cathode is not feasible. Nevertheless, the results confirm that the distribution of the carbon framework is highly heterogeneous in the composite cathode, which suggests a reduced contact area between the RGO framework and LPSC1 SE. It was expected that the contact area (if any) between RGO and LPSC1 SE will still lead to unwanted side reactions because the functionalities of the carbon were not controlled. The shading in FIGS. 4A-4D indicate LPSC1 only areas from the LPSC1 SE. Each shading has a slightly different peak shape at Raman shift below 700 cm 1, which is attributable to the distinct local structural environments.

In contrast, FIGS. 4B and 4D display a composite cathode where CNFs were randomly mixed with LPSC1 SE and pc-NMC811 particles using a mortar and pestle. In this control group, a homogeneous carbon-rich Raman response is observed throughout the mapping, indicating an even distribution of CNFs in the composite cathode. It is expected that the homogeneous distribution of carbon in the composite cathode may facilitate uniform electron transfer throughout the composite cathode; however, it does not prevent detrimental contact between carbon and the LPSC1 SE. These findings indicate that the composite cathode design, featuring conductive carbon embedded beneath the cathode active material, can effectively reduce the interfacial area between carbon and the LPSC1 SE. It is anticipated that carbon embedded beneath the cathode particles can still provide facile electron transport pathways to the cathode particles.

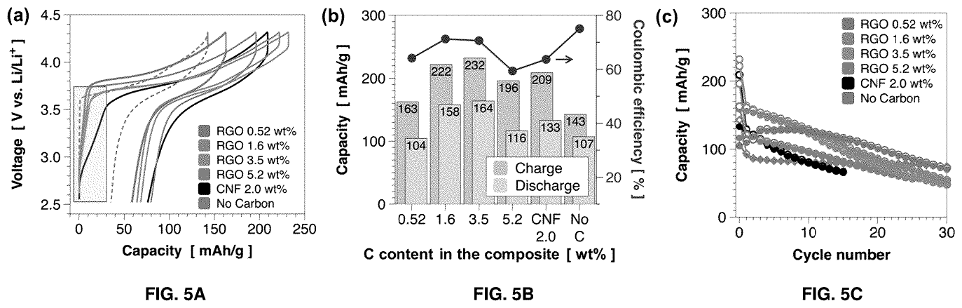

FIG. 5A presents charge-discharge profiles of the pc-NMC811/RGO composite cathodes with varied RGO contents, a CNF composite cathode, and a cathode without carbon additive. The composite cathodes were prepared by mixing RGO composites (78 wt %) and LPSC1 SEs (22 wt %). Li—In (composition: Li_{0.22}In_{0.78}) alloy anodes were used, and the voltage was converted to vs. Li/Lit. All the solid-state battery cells were tested at 50° C. under 30 MPa. The composite cathode with CNF shows a relatively large charge capacity in the low-voltage regions below 3.5 V (vs. Li/Li⁺), whereas the control group without carbon additive shows no capacity in the low-voltage regions (indicated by the box in FIG. 5A). These results confirm that the capacity obtained from the low-voltage regions <3.5 V (vs. Li/Li⁺) originates from the decomposition of LPSC1 at LPSC1/carbon interfaces. Interestingly, unwanted side reactions at <3.5 V (vs. Li/Li⁺) are greatly suppressed in the RGO composite cathode, as indicated in the boxed area in FIG. 5A.

FIG. 5B summarizes the charge and discharge capacities in the first cycle. The charge and discharge capacities gradually increase as the RGO content increases from 0.52 wt % to 3.5 wt % from 163 to 232 mA h g⁻¹ for charging and from 104 to 164 mA h g⁻¹ for discharging at C/10 (1C=200 mA g 1). The charge and discharge capacities decrease when the RGO content increases to 5.2 wt %. In addition, the composite cathode with 5.2 wt % RGO has lower coulombic efficiency (59.4%) than the composite cathodes with lower RGO contents (71.2% for 1.6 wt % RGO and 70.6% for 3.5 wt % RGO). Low coulombic efficiency in 5.2 wt % RGO sample could be related to the RGO framework surfaces which are not covered by pc-NMC811 particles that led to the decomposition of LPSC1 at the interface during the charge process. The 3.5 wt % RGO and 1.6 wt % RGO composites exhibited improved reversible discharge capacities and coulombic efficiency compared with the composite cathode containing CNF (2 wt %), as shown in FIG. 5B. It was also found that the 3.5 wt % RGO and 1.6 wt % RGO composites showed lower polarization than the composite cathode containing CNF in FIG. 5A. The improved capacities and coulombic efficiencies can be attributed to the electronically conductive carbon being embedded beneath the pc-NMC811 particles and less carbon surface forming interfaces with LPSC1 in the RGO composite system.

FIG. 5C shows the cycling stability of the pc-NMC811/RGO composites and control groups. All the RGO composites delivered improved cycling stability compared with the composite cathode with CNF. More specifically, the 3.5 wt % RGO and 1.6 wt % RGO composites maintain 94.7 and 106 mA h g 1, respectively, after 15 cycles. The 0.52 wt % RGO composite exhibited lower discharge capacity in the first cycle than the other RGO composites, but it retained the highest capacity of 114.6 mA h g⁻¹ after 15 cycles and 70 mA h g⁻¹ after 30 cycles. Nevertheless, capacity decay was still observed as cycling progressed in the RGO composites. SEM confirmed that some primary NMC811 particles were detached from the secondary particle. In these RGO composites, the detached particles could not be connected to electronically conductive carbon, and their surfaces were not protected by a LNO coating layer, which may have led to capacity degradation upon repeated charge-discharge cycling. Therefore, the study was extended to single-crystal NMC particles, as discussed in the next example.

### EXAMPLE—Single-Crystalline LiNi_{0.6}Mn_{0.2}Co_{0.2}O₂/RGO Framework Composite Results

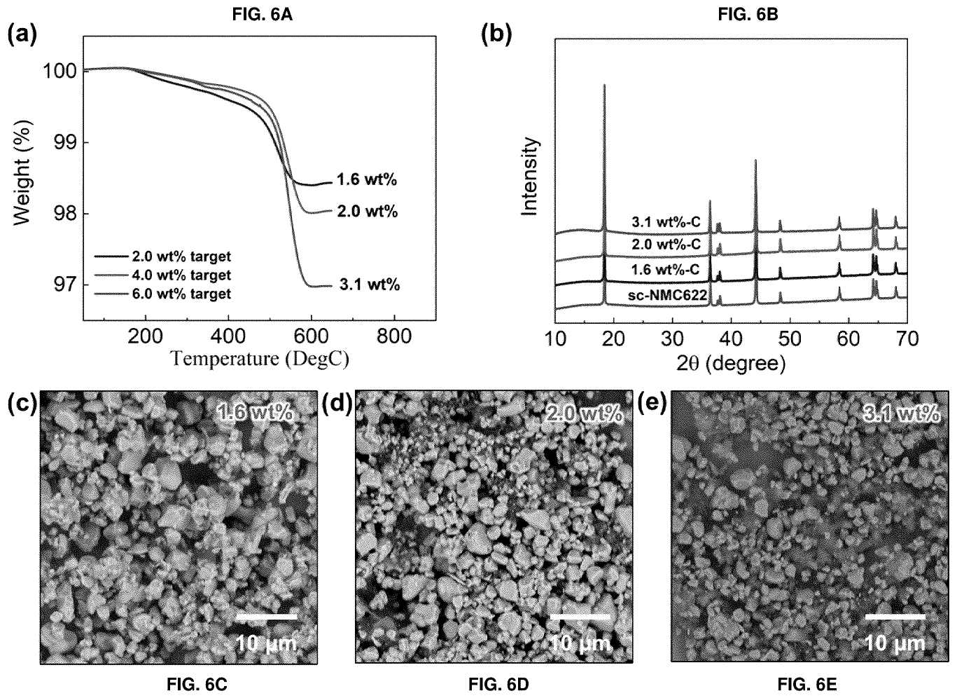

LNO-coated single-crystal NMC622 (sc-NMC622) cathode particles (particle size: 1-5 μm) were used to create the RGO composite to avoid the issue of particle detachment from the secondary particle agglomerates that occurred in pc-NMC811/RGO composites. The same synthesis procedures that were applied to the pc-NMC811/RGO composites were used for the synthesis of sc-NMC622/RGO composites. FIG. 6A presents the TGA results of the sc-NMC622/RGO composites. The target RGO contents in the synthesis process were 2 wt %, 4 wt %, and 6 wt %. The weight loss from 100° C. to 650° C. of the sc-NMC622/RGO in TGA is attributable to the decomposition of any carbon in the composite, which includes RGO and porous carbon. Hereafter, the RGO content is used to refer to the carbon content in the composite structure for simplicity. The RGO contents were estimated to be 1.6 wt %, 2.0 wt %, and 3.1 wt %, respectively, in the composites. Hereafter, the estimated RGO contents will be used to refer to the samples.

No changes in the XRD patterns of sc-NMC622 were observed after the RGO composite synthesis, as shown in FIG. 6B, indicating that the synthesis process does not affect the crystal structure of the sc-NMC622 particles and that decomposition of sc-NMC622 did not occur. FIGS. 6C-6E display SEM images of sc-NMC622/RGO composites at varied RGO contents. In the 1.6 wt % RGO sample, the RGO surface is fully decorated with sc-NMC622 particles, and it is difficult to observe the RGO surface in FIG. 6C. This structure can reduce the contact area between carbon framework and LPSC1 SE in the composite cathode structure. However, it is suspected that some sc-NMC622 particles may not be directly connected to the electronically conductive RGO framework due to a high sc-NMC622 loading on the RGO framework, which can increase the polarization in the electrochemical test. When the RGO content increased to 2.0 wt %, some of the RGO was detected under the sc-NMC622 particles in the SEM image (FIG. 6D). When the RGO content increased up to 3.1 wt %, more RGO surfaces were exposed and not covered by sc-NMC622 particles. These uncovered surfaces likely react with the LPSC1 SE in the composite cathode.

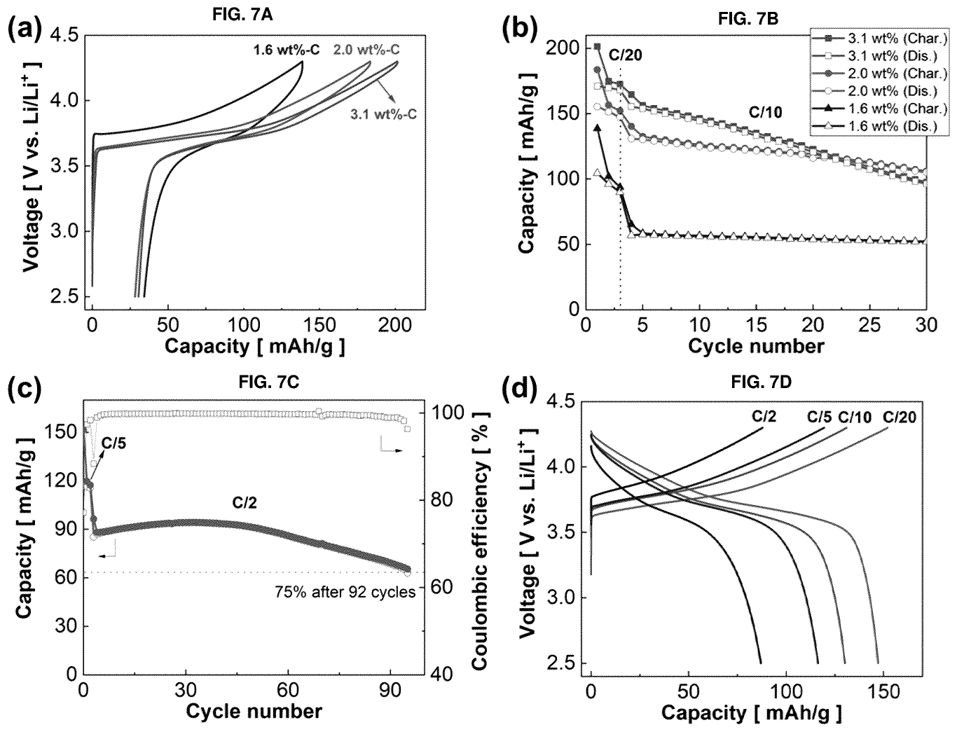

The three sc-NMC622/RGO composites were tested in ASSB cells using LPSC1 as the SE and a Li—In (composition: Li_{0.22}In_{0.78}) alloy as the counter electrode. Electrochemical tests were conducted at 50° C. under 30 MPa. FIG. 7A presents charge-discharge profiles of the sc-NMC622/RGO composites with varied RGO contents of 1.6 wt %, 2.0 wt %, and 3.1 wt %. The first charge and discharge capacities were 138.6 mA h g⁻¹ (charge) and 104.4 mA h g⁻¹ (discharge), 183.5 mA h g⁻¹ (charge) and 155.4 mA h g⁻¹ (discharge), and 201.4 mA h g⁻¹ (charge) and 171.0 mA h g⁻¹ (discharge) for the 1.6 wt %, 2.0 wt %, and 3.1 wt % RGO composites, respectively, at C/20 (1C=170 mA g 1). The first cycle coulombic efficiency of the 1.6 wt %, 2.0 wt %, and 3.1 wt % RGO composites are 75.3%, 84.7%, and 84.9%, respectively. A magnification of the first portion of FIG. 7A shows that the capacity obtained in a relatively low-voltage region (<3.5 V vs. Li/Li⁺) decreases when the RGO content decreases. This result indicates that the RGO composite with lower RGO content has a lower interfacial area between the RGO framework and LPSC1 SE in the composite cathode. However, the RGO composite with low RGO content (1.6 wt %) exhibits a larger polarization than the RGO composites with higher RGO contents (2.0 wt % and 3.1 wt %). These results may indicate that some of the sc-NMC622 particles are not connected to the electronically conductive RGO framework in the 1.6 wt % RGO composite because of the low RGO content. Notably, much lower charge capacity at <3.5 V vs. Li/Li⁺ was observed in the sc-NMC622/RGO composites compared with the pc-NMC811/RGO composites. This is attributable to the sc-NMC622 particles being well connected to the RGO framework without breaking.

FIG. 7B shows the cycling stability of the sc-NMC622/RGO composites. The initial three cycles were performed at C/20, and the current rate increased to C/10 for the following cycles. After 30 cycles, the 3.1 wt % RGO composite maintains a capacity of 96.2 mA h g 1, corresponding to 62% retention at C/10. The 2.0 wt % RGO and 1.6 wt % RGO composites retained capacities of 105.0 and 52.0 mA h g 1, which correspond to capacity retention of 80% and 91.5%, respectively, after 30 cycles at C/10. A trade-off in the RGO content of the composite was found—a high RGO content delivered higher first discharge capacity but showed faster capacity decay over cycles than lower RGO content.

FIG. 7C shows the cycling stability of the 2.0 wt % RGO composite at C/2 after the initial three cycles at C/5. The 2.0 wt % RGO composite maintains 75% (63.0 mA h g 1) of the capacity at C/2 after 92 cycles. The first-cycle coulombic efficiency is 77.1% and increases gradually upon cycling up to 99.7-99.96%, which might indicate the formation of passivating cathode-electrolyte interphase (CEI). After 60 cycles, the coulombic efficiency and capacity begins to decrease.

FIG. 7D displays the charge-discharge profiles of the 2.0 wt % RGO composite at varied current rates of C/20, C/10, C/5, and C/2. The 2.0 wt % RGO composite delivered capacities of 147.1, 130.2, 116.4, and 87.0 mA g⁻¹ at C/20, C/10, C/5, and C/2, respectively.

### CONCLUSION

As described herein, a conductive 3D RGO framework embedded beneath the CAM (pc-NMC811 and sc-NMC622) was developed. In the composite cathode for the solid-state battery, the newly developed composite of NMC particles decorated on the 3D RGO framework exhibited higher specific capacity and improved cycling stability compared with a typical composite cathode, where the CAM, CNF, and LPSC1 SE are homogeneously mixed. In the composite cathode where the NMC/RGO composite and LPSC1 SE were mixed, the heterogeneous distribution of the electronically conductive RGO framework, which preferably contacted with NMC particles, prevented the formation of a detrimental interface between RGO framework and LPSC1 SE. This demonstrates the importance of designing carbon-CAM composite structures where the electronically conductive carbon is embedded beneath the CAM to provide facilitated electron pathways while preventing direct contact between the carbon and SE in the composite cathode of solid-state batteries.

Further details regarding the embodiments described herein can be found in Young-Woon Byeon et al., “Conductive carbon embedded beneath cathode active material for longevity of solid-state batteries,” J. Mater. Chem. A, 2024,12, 8359-8369, which is hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
depositing a polymer coating on cathode material particles to be used in a battery, the polymer coating giving the cathode material particles a positive charge; and
mixing the cathode material particles with carbon structures, the carbon structures having a negative charge, and the cathode material particles becoming attached to surfaces of the carbon structures.

2. The method of claim 1, wherein the polymer coating is deposited using a solution-based process.

3. The method of claim 1, wherein the polymer coating deposited on the cathode material particles is about 1 nanometer to 20 nanometers thick.

4. The method of claim 1, wherein the polymer of the polymer coating comprises a cationic polymer.

5. The method of claim 1, wherein the polymer of the polymer coating is a polymer from a group polyethylenimine (PEI), poly(L-lysine) (PLL), poly(amidoamine) (PANAM), and poly(β-amino ester).

6. The method of claim 1, wherein the cathode material particles are a material from a group lithium nickel cobalt oxide, lithium nickel cobalt manganese oxide, lithium nickel cobalt aluminum oxide, lithium iron phosphate, lithium iron manganese phosphate, and doped-compositions of the foregoing.

7. The method of claim 1, wherein the cathode material particles are a cathode material from a group LiCoO₂, LiNiₓCo_{y}Mn₂O₂, LiNiₓCo_{y}Al₂O₂, LiFePO₄, and LiFeₓMn₁₋ₓPO₄.

8. The method of claim 1, wherein the cathode material particles have dimensions of about 0.1 microns to 100 microns.

9. The method of claim 1, wherein the battery is a solid state battery.

10. The method of claim 1, wherein the carbon structures are selected from a group frameworks of a three-dimensional reduced graphene oxide (RGO), carbon nanofibers, carbon microfibers, carbon nanotubes, carbon nanosheets, carbon microsheets, carbon nanoplates, and carbon microplates.

11. The method of claim 1, wherein the carbon structures have dimensions of about 1 micron to 1,000 microns.

12. The method of claim 1, wherein a ratio by weight of the carbon structures to the cathode material particles is about 1:200 to 1:10.

13. The method of claim 1, further comprising:
mixing the carbon structures having the cathode material particles attached to their surfaces with solid electrolyte particles.

14. The method of claim 13, wherein the solid electrolyte particles are selected from a group sulfide-based solid electrolyte particles, oxy-sulfide-based solid electrolyte particles, halide-based solid electrolyte particle, and oxy-halide based solid electrolyte particles.

15. The method of claim 13, wherein the solid electrolyte particles comprise lithium phosphorus sulfur chloride (LiPSC1) particles.

16. The method of claim 13, wherein the solid electrolyte particles have dimensions of about 0.5 microns to 10 microns.

17. A device comprising:
a cathode, the cathode comprising cathode material particles, solid electrolyte particles, and carbon structures, the cathode material particles having a polymer coating disposed on surfaces of the cathode material particles, the cathode materials particles being disposed on surfaces of the carbon structures;
a solid electrolyte disposed on the cathode; and
an anode disposed on the solid electrolyte.

18. The device of claim 17, wherein the cathode material particles prevent contact between the carbon structures and the solid electrolyte particles.

19. The device of claim 17, wherein the polymer of the polymer coating is a polymer from a group polyethylenimine (PEI), poly(L-lysine) (PLL), poly(amidoamine) (PANAM), and poly(β-amino ester).

20. The device of claim 17, wherein the cathode material particles are a material from a group lithium nickel cobalt oxide, lithium nickel cobalt manganese oxide, lithium nickel cobalt aluminum oxide, lithium iron phosphate, lithium iron manganese phosphate, and doped-compositions of the foregoing.
